(19) United States
(12) Patent Application Publication
(10) Pub. No.: US 2011/0025568 A1
(43) Pub. Date: Feb. 3, 2011

(54) SUBSTITUTE ANTENNA

(75) Inventor: Tsutomu Totani, Aichi (JP)

Correspondence Address: POSZ LAW GROUP, PLC, 12040 SOUTH LAKES DRIVE, SUITE 101, RESTON, VA, 20191, US

(73) Assignee: BEAT-SONIC CO., LTD., Nisshin-shi, Aichi (JP)

(21) Appl. No.: 12/309,768

(22) PCT Filed: Jul. 10, 2008
(86) PCT No.: PCT/JP2008/062462

§ 371 Date: Jan. 29, 2009

(30) Foreign Application Priority Data
Mar. 12, 2008 (JP) 2008-063117

(51) Int. Cl. H01Q 1/32

(52) U.S. Cl. 343/713

(57) ABSTRACT

A base from which a monopole antenna has been detached is covered by a synthetic-resin cover with an antenna wire inserted into an antenna insertion portion, and electrical connection to inner wiring is ensured by a connecting lead. Subsequently, a two-sided adhesive tape attached to a joint surface formed on a peripheral edge 4 of the cover is adhered to a roof panel such that a substitute antenna is mounted on the roof panel. The substitute antenna can easily be substituted for an existing monopole antenna mounted as a genuine part of a vehicle by utilizing a mounting base of the monopole antenna.

### TECHNICAL FIELD

The present invention relates to a substitute antenna which is substituted for an existing monopole antenna mounted as a genuine part of a vehicle.

### BACKGROUND ART

A monopole antenna mounted on a roof panel of a vehicle has a possibility of being hit on the ceiling of an indoor parking lot or being bent or broken during vehicle wash. Furthermore, the monopole antenna produces wind roar during high-speed running of the vehicle. For this reason, Japanese patent application publication JP-A-2004-363747 discloses an antenna to be substituted for the monopole antenna.

However, the antenna disclosed by the aforenoted gazette is devised to be mounted on a roof panel but is not devised to be substituted for a monopole antenna mounted as a genuine part of a vehicle. Patent document 1: Japanese patent application publication JP-A-2004-363747

### DISCLOSURE OF THE INVENTION

Problem to be Overcome by the Invention

An object of the present invention is to provide a substitute antenna which can easily be substituted for an existing monopole antenna using a mounting base which is mounted on a roof panel of a vehicle and on which the monopole antenna is caused to stand.

### MEANS FOR OVERCOMING THE PROBLEM

To achieve the object, a substitute antenna described in claim 1 is characterized in that a synthetic-resin cover with an antenna provided inside is put on a mounting base which is mounted on a roof panel of a vehicle and on which a monopole antenna is caused to stand, a lead for connection of the antenna is connected to a hole which is formed in the mounting base and in which the monopole antenna stands so that electrical connection to internal wiring is ensured, and a joint surface formed on a peripheral edge of a bottom opening of the cover is joined to the roof panel thereby to be attached to the roof panel, whereby the substitute antenna is substituted for the existing monopole antenna.

The substitute antenna described in claim 2 is characterized in that in the construction described in claim 1, the antenna is a conductive film antenna with a synthetic-resin film formed with a conductive pattern and is attached to an inner surface of the cover.

The substitute antenna described in claim 3 is characterized in that in the construction described in claim 2, the conductive pattern is a zigzag pattern.

The substitute antenna described in claim 4 is characterized in that in the construction described in claim 2, the conductive pattern is a spiral pattern.

The substitute antenna described in claim 5 is characterized in that in the construction described in claim 1, the antenna is embedded in the synthetic-resin cover.

The substitute antenna described in claim 6 is characterized in that in the construction described in any one of claims 1 to 5, a lug terminal cable with a lug terminal on one end thereof has the other end to which a connecting terminal is mounted, the connecting terminal is connected to a terminal mounted to a distal end of the connecting lead, the lug terminal is fitted with a fastening screw and is fastened to the standing hole of the monopole antenna, thereby ensuring electrical connection to the internal wiring.

The substitute antenna described in claim 7 is characterized in that in the construction described in any one of claims 1 to 6, the joint surface of the cover is joined to the roof panel by a two-sided adhesive tape.

The substitute antenna described in claim 8 is characterized in that in the construction described in any one of claims 1 to 7, the cover is formed so as to be tapered toward a front of the vehicle.

### EFFECT OF THE INVENTION

According to the substitute antenna described in claim 1, the mounting base from which the monopole antenna has been detached is covered with the synthetic-resin cover with the antenna provided inside, and the connecting lead for the antenna is connected to the hole which is formed in the mounting base for the mounting of the monopole antenna so that electrical connection to internal wiring is ensured. The joint surface formed on a peripheral edge of a bottom opening of the cover is joined to the roof panel thereby to be attached to the roof panel. Consequently, the substitute antenna can easily be substituted for the existing monopole antenna as the genuine part by utilizing the mounting base for the monopole antenna.

According to the substitute antenna described in claim 2, the antenna is a conductive film antenna with a synthetic-resin film formed with a conductive pattern and is attached to an inner surface of the cover. The height of the cover is rendered minimum such that a part of the cover projecting from the roof panel can be reduced, and the antenna can be substituted more easily.

According to the substitute antenna described in claim 3, the conductive pattern is a zigzag pattern. Accordingly, an antenna efficiency can be improved.

According to the substitute antenna described in claim 4, the conductive pattern is a spiral pattern. Accordingly, an antenna efficiency can be improved.

According to the substitute antenna described in claim 5, the antenna is embedded in the synthetic-resin cover so as to be integral with the antenna. Consequently, the height of the cover is rendered minimum such that a part of the cover projecting from the roof panel can be reduced, and the antenna can be substituted more easily.

According to the substitute antenna described in claim 6, a lug terminal cable with a lug terminal on one end thereof has the other end to which a connecting terminal is mounted, the connecting terminal is connected to a terminal mounted to a distal end of the connecting lead, the lug terminal is fitted with a fastening screw and is fastened to the standing hole of the monopole antenna, thereby ensuring electrical connection to the internal wiring. Accordingly, the antenna can quickly be substituted in vehicles with different fastening screw standards when a plurality of types of lug terminal cables of the lug terminals are prepared according to the fastening screw standards.

According to the substitute antenna described in claim 7, the joint surface of the cover is joined to the roof panel by the two-sided adhesive tape. Accordingly, a substituting work can be carried out more easily and more quickly.

According to the substitute antenna described in claim 8, the cover is formed so as to be tapered toward the front of the vehicle. Accordingly, an amount of wind roar can be reduced during high-speed running of the vehicle.

### EMBODIMENT

The substitute antenna 1 in accordance with the present invention will be described with reference to the accompanying drawings. FIG. 1 is a partially sectional perspective view of the substitute antenna 1. The substitute antenna 1 comprises a synthetic-resin cover 2 and an antenna wire 7. The cover 2 is formed substantially into a boat form and has one tapered end corresponding to the front of a vehicle to which the antenna 1 is to be attached. The cover 2 has an upper surface on which a boat-shaped protrusion 2a in planar view is integrally formed. The protrusion 2a has an inner antenna wire insertion portion 2b continuous to an interior of the cover 2. The cover 2 has an open bottom 4 with a peripheral edge, which is formed with a joint surface 5 which is to be joined to a roof panel 100 of a vehicle as will be described later. A two-sided adhesive tape 6 is adhered to the joint surface 5.

An antenna wire 7 bent into a zigzag shape is inserted into the antenna wire insertion portion 2b of the protrusion 2a of the cover 2, then being fixed by an adhesive agent or the like. A connecting lead 8 for connection to the antenna wire 7 is drawn out into the interior 3 of the cover 2. The connecting lead 8 has a distal end to which a connecting female connector 8a is mounted. Into the female connector 8a of the connecting lead 8 is inserted a male connector 10a of a lug terminal cable 10 which has a distal end to which a ring-shaped lug terminal 9 is mounted.

On the other hand, a mounting base 102 on which a monopole antenna 101 is mounted so as to stand is attached to a roof panel 100 of the vehicle to which the substitute antenna 1 is attached. The base 102 includes a mounting bolt 103 and a female screw 104 both formed integrally therewith. The monopole antenna 101 is threadingly engaged with the female screw 104. One end of the lead 105 is connected to a part of the female screw 104 and then inserted through a through hole 103a formed through the center of the mounting bolt 103. A connector 106 for connection to internal wire (not shown9 is mounted on the distal end of the lead 105. The roof panel 100 is formed with amounting hole 107. Rubber packings 108 are provided on outer and inner faces of the roof panel 100 so that the mounting hole 107 is located therebetween. The mounting bolt 103 is inserted through the mounting hole 107, and a nut 109 is threadingly engaged with the mounting bolt 103 to be tightened up.

In mounting the substitute antenna 1, the monopole antenna 101 is firstly detached from the base 102. A tightening screw 110 is inserted through the lug terminal 9 of the lug terminal cable 10 and threadingly engaged with the female screw 104 of the base 102, whereby electrical connection to the inner wiring is ensured. Subsequently, the cover 2 is attached to the base 102 so that the base 102 is covered with the cover 2. The two-sided adhesive tape 6 attached to the joint surface 5 of the open bottom 4.

The base 2 from which the monopole antenna 7 has been detached is covered by the synthetic-resin cover 2 with the antenna insertion portion 2b into which the antenna wire 7 has been inserted, as described above. Furthermore, after electrical connection to the inner wiring has been ensured by the connecting lead 8 of the antenna wire 7 and the lug terminal cable 10 connected to the connecting lead 8, the two-sided adhesive tape 6 attached to the joint surface 5 formed on the peripheral edge of the cover 2 is adhered to the roof panel 100. The substitute antenna 1 can easily be substituted for the existing monopole antenna 101 utilizing the mounting base 102 of the antenna 101.

Furthermore, the lug terminal 9 is provided on one end of the lug terminal cable 10, and the male connector 10a is mounted to the other end of the lug terminal cable 10. The male connector 10a is connected to the female connector 8a mounted on the distal end of the connecting lead 8. The lug terminal 9 is fitted with the fastening screw 110, which is then fastened against the female screw 104 of the mounting base 102 for the monopole antenna, whereby electrical connection to the inner wiring is ensured. Consequently, the antenna can quickly be substituted in vehicles with different fastening screw standards when a plurality of types of lug terminal cables 10 of the lug terminals 9 are prepared according to the fastening screw standards.

FIG. 2 shows the substitute antenna 11 of a modified form. The synthetic-resin cover 12 is formed substantially into a boat form in planar view and has a stream-lined expanded portion 12a on one end thereof corresponding to the front of a vehicle. The cover 12 is formed so that the height thereof is gradually reduced toward the other end thereof. The cover 12 has an open bottom 14 with a peripheral edge 15, which is formed with a joint surface 16 which is to be joined to a roof panel 100 of the vehicle. The two-sided adhesive tape 17 is adhered to the joint surface 16.

A conductive film antenna 19 is bonded to a ceiling 18 of the cover 12. The conductive film antenna 19 comprises a plastic film 20 formed with a conductive pattern. A connecting lead 21 is attached to the conductive film antenna 19. The connecting lead 21 has a distal end to which a connecting female connector 21a is attached. Into the female connector 21a of the connecting lead 21 is inserted a male connector 23a of the lug terminal cable 23 which has a distal end to which a ring-shaped lug terminal 22 is attached, whereby the connecting lead 21 and the lug terminal cable 23 are connected to each other.

A conducive pattern of the conductive film antenna 19 includes a zigzag pattern 24a as shown in FIG. 3A, a spiral pattern 24b as shown in FIG. 3B. An antenna efficiency can be improved when the conductive film antenna 19 is formed into one of the patterns. Furthermore, the antenna can quickly be substituted in vehicles with different fastening screw standards when a plurality of types of lug terminal cables 23 of the lug terminals 22 are prepared according to the fastening screw standards.

The antenna wire and the conductive pattern can be inserted during the forming of the synthetic-resin cover 12 thereby to be formed integrally with the cover 12.

A manner of mounting the substitute antenna 11 of the modified form is the same as described above regarding the substitute antenna 1. Accordingly, detailed description will be eliminated.

The synthetic-resin cover 12 has the stream-lined expanded portion 12a formed on one end thereof corresponding to the front of a vehicle. The cover 12 is formed so that the height thereof is gradually reduced from the expanded portion 12a toward the other end thereof. Consequently, the travel resistance of the vehicle is decreased such that an amount of wind roar can be reduced during high-speed running of the vehicle. Furthermore, the conductive film antenna 19 formed with the conductive pattern on the plastic film 20 is bonded to the ceiling 18 of the cover 12. Consequently, the height of the cover 12 is rendered minimum such that a part of the cover 12 projecting from the roof panel 100 can be reduced, and the antenna can be substituted more easily.

Furthermore, when the antenna wire 7 is embedded in the synthetic-resin cover 2 so as to be integral with the cover 2, the height of the cover 2 is rendered minimum such that a part of the cover 2 projecting from the roof panel 100 can be reduced, and the antenna can be substituted more easily. Furthermore, since the cover 2 is formed so as to be tapered at least toward the front of the vehicle, an amount of wind roar can be reduced during high-speed running of the vehicle.

Small screws may be used when the cover 2 or 12 is attached to the roof panel 100 or may be directly bonded to the roof panel 100 by the adhesive agent.

### BRIEF DESCRIPTION OF THE DRAWINGS

FIG. 1 is a partially sectional perspective view of a substitute antenna;

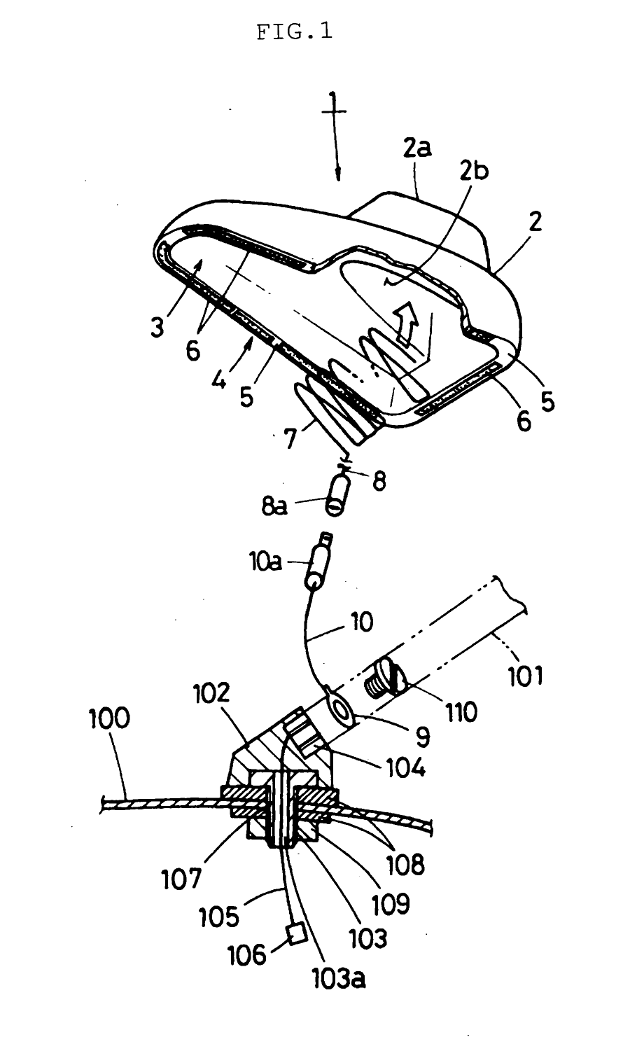

FIG. 2 is a side view of the substitute antenna of a modified form; and

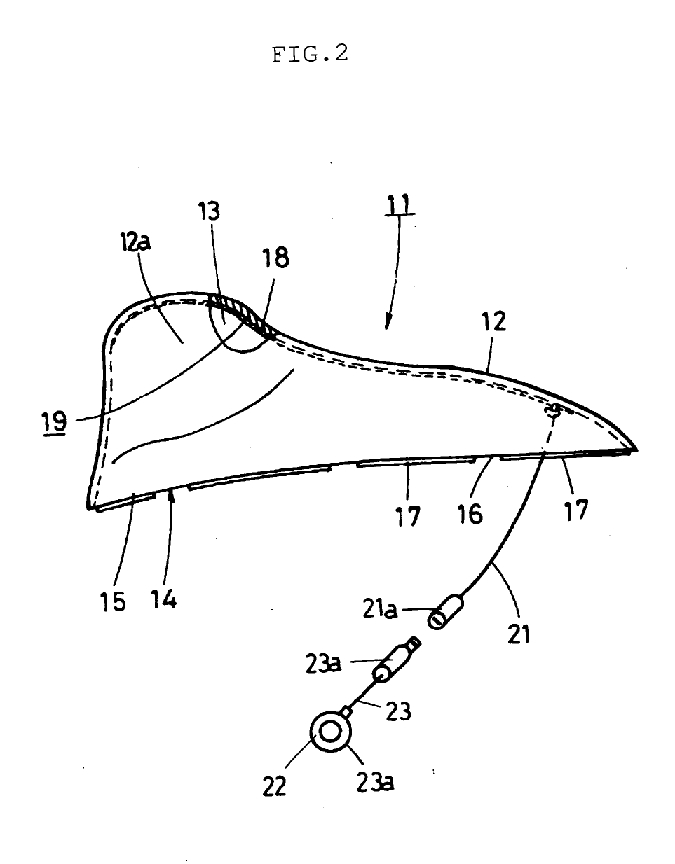

FIGS. 3A and 3B are plan views exemplifying conductive patterns of a conductive film antenna.

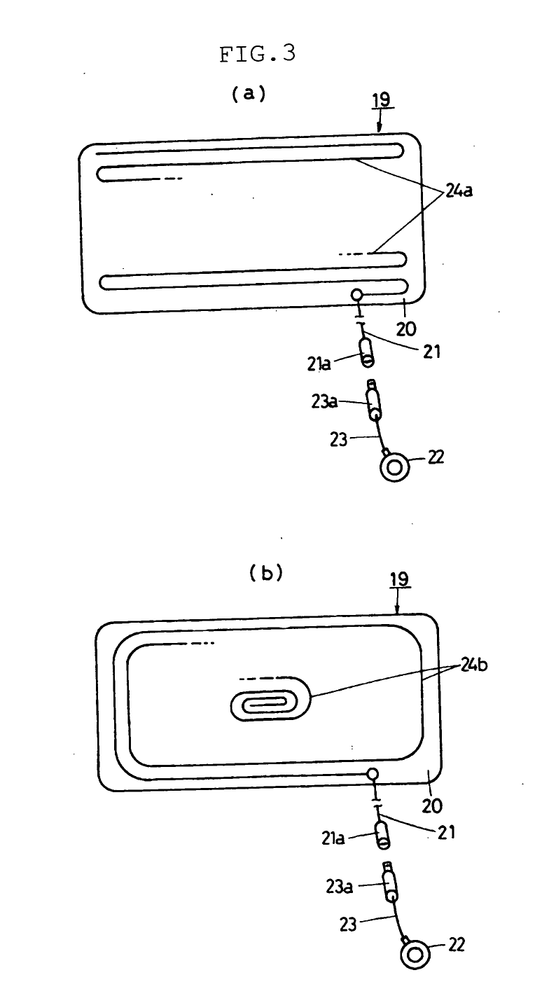

### EXPLANATION OF REFERENCE SYMBOLS

1, 11: substitute antenna

2, 12: cover

3, 13: interior

4, 15: peripheral edge

5, 16: joint surface

6, 17: two-sided adhesive tape

7: antenna wire

8, 21: connecting lead

8a, 21a: female connector

9, 22: lug terminal

10, 23: lug terminal cable

10a, 23a: male connector

19: conductive film antenna

20: plastic film

24a, 24b: conductive pattern

100: roof panel

101: monopole antenna

102: base

104: female screw

110: fastening screw

1. A substitute antenna characterized in that a synthetic-resin cover with an antenna provided inside is put on a mounting base which is mounted on a roof panel of a vehicle and on which a monopole antenna is mounted so as to stand, a lead for connection of the antenna is connected to a hole which is formed in the mounting base and in which the monopole antenna stands so that electrical connection to internal wiring is ensured, and a joint surface formed on a peripheral edge of a bottom opening of the cover is joined to the roof panel thereby to be attached to the roof panel, whereby the substitute antenna is substituted for the existing monopole antenna.

2. The substitute antenna according to claim 1, wherein the antenna is a conductive film antenna with a synthetic-resin film formed with a conductive pattern and is attached to an inner surface of the cover.

3. The substitute antenna according to claim 2, wherein the conductive pattern is a zigzag pattern.

4. The substitute antenna according to claim 2, wherein the conductive pattern is a spiral pattern.

5. The substitute antenna according to claim 1, wherein the antenna is embedded in the synthetic-resin cover.

6. The substitute antenna according to claim 1, wherein a lug terminal cable with a lug terminal on one end thereof has the other end to which a connecting terminal is mounted, the connecting terminal is connected to a terminal mounted to a distal end of the connecting lead, the lug terminal is fitted with a fastening screw and is fastened to the standing hole of the monopole antenna, thereby ensuring electrical connection to the internal wiring.

7. The substitute antenna according to claim 1, wherein the joint surface of the cover is joined to the roof panel by a two-sided adhesive tape.

8. The substitute antenna according to claim 1, wherein the cover is formed so as to be tapered toward a front of the vehicle.
